(19) United States
(12) Patent Application Publication
(10) Pub. No.: US 2011/0059304 A1
(43) Pub. Date: Mar. 10, 2011

(54) DRY FILM AND MANUFACTURING METHOD OF DRY FILM

(75) Inventor: Yoshitaka USHIYAMA, Kanagawa (JP)

(73) Assignee: RENESAS ELECTRONICS CORPORATION, Kawasaki-shi (JP)

(21) Appl. No.: 12/875,443

(22) Filed: Sep. 3, 2010

(30) Foreign Application Priority Data
Sep. 8, 2009 (JP) 2009-207073

(51) Int. Cl. B32B 27/00; B05D 1/36

(52) U.S. Cl. 428/213; 428/411.1; 427/407.1

(57) ABSTRACT

A dry film includes a first solder resist film, a second solder resist film and a supporting film. The first solder resist film includes first particles of first elastomer. The supporting film supports the first solder resist film and the second solder resist film. Adhesion strength of a surface of the second solder resist film is weaker than adhesion strength of a surface of the first solder resist film at a glass transition point of the first elastomer. According to the dry film, it is possible to form a wiring board including a solder resist film which is arranged at a surface of the wiring board and hard to be adhered to a body such as a die upon heating.

This application is based upon and claims the benefit of priority from Japanese patent application No. 2009-207073, filed on Sep. 8, 2009, the disclosure of which is incorporated herein in its entirety by reference.

### BACKGROUND OF THE INVENTION

1. Field of the Invention

The present invention relates to a solder resist, and in particular, a dry film solder resist.

2. Description of Related Art

A wiring board is provided with a solder resist film formed at a surface thereof to protect a wiring pattern from an external influence such as dusts and humidity and to prevent a solder from being in contact with an unnecessary part to cause a short circuit. A technique relating to a solder resist film is disclosed in Japanese patent publication (JP-P2005-331932A).

In a semiconductor device, a semiconductor element, a semiconductor package or the like is mounted on a surface of a wiring board protected with a solder resist. A manufacturing process of the semiconductor device includes a resin sealing process to protect the semiconductor element from external environment. The resin sealing process includes steps of: enclosing the wiring board on which the semiconductor element is mounted with dies; filling a cavity of the dies with sealing resin fluidized at a high temperature; curing the filled sealing resin; and taking out the semiconductor device (semiconductor package) including the cured resin from the dies.

A technique relating to the step of taking out the semiconductor device from dies is disclosed in Japanese patent publication (JP-P2002-166449A). A resin molding apparatus disclosed in Japanese patent publication (JP-P2002-166449A), after resin is filled in a cavity and molded, dies are opened while removing a molded product from the cavity by protruding ejector pins. The resin molding apparatus is provided with a suction device which sucks air to fix the molded product on a parting surface of the die when the dies are opened. According to such resin molding apparatus, an automatic resin molding process can be smoothly performed.

As described above, the wiring board is provided with the insulating solder resist film at the surface thereof. The solder resist film is formed for protecting the wiring board. Furthermore, the solder resist film can withstand a strain due to thermal deformation. In particular, when the solder resist film is positioned at a junction between the wiring board and the semiconductor element, the solder resist film is required to withstand a strain due to thermal deformation of the wiring board and the semiconductor element in the resin sealing process. Therefore, the solder resist film includes elastomer to relieve an internal stress.

The present inventor has recognized as follows with respect to the step of taking out the semiconductor device from the dies. In addition to a difficulty in a removal (release) of the molded resin from the dies, the elastomer included in the solder resist film tends to be adhered to the die since the elastomer is softened by heat in the resin sealing process, which makes it difficult to taking out the molded semiconductor device from the dies.

### SUMMARY

In one embodiment, a dry film includes a first solder resist film, a second solder resist film and a supporting film. The first solder resist film includes first particles of first elastomer. The supporting film supports the first solder resist film and the second solder resist film. Adhesion strength of a surface of the second solder resist film is weaker than adhesion strength of a surface of the first solder resist film at a glass transition point of the first elastomer.

In another embodiment, a manufacturing method of a dry film includes: forming one of a first solder resist film and a second solder resist film on a supporting film; and farming another of the first solder resist film and the second solder resist film on or above one of the first solder resist film and the solder resist film. The first solder resist film includes first particles of first elastomer. Adhesion strength of a surface of the second solder resist film is weaker than adhesion strength of a surface of the first solder resist film at a glass transition point of the first elastomer.

The dry film can be bonded to an insulating layer and a wiring layer formed thereon such that the first solder resist film is arranged between the insulating layer and the second solder resist film, in order to farm a wiring board including the insulating layer, the wiring layer, the first solder resist film and the second solder resist film. Accordingly, the second solder resist film is arranged at a surface of the wiring board. Here, the adhesion strength of the surface of the second solder resist film is weaker than the adhesion strength of the surface of the first solder resist film at the glass transition point of the first elastomer.

According to the dry film, it is possible to form a wiring board including a solder resist film which is arranged at a surface of the wiring board and hard to be adhered to a body such as a die upon heating.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a sectional view of a dry film 1 according to a first embodiment of the present invention;

FIG. 2 is a partial sectional view of a wiring board 50 including a solder resist film 20A and a solder resist film 30A formed by curing a solder resist film 20 and a solder resist film 30 based on a resist pattern;

FIG. 3 is an enlarged view of a portion in a circle A shown in FIG. 2;

FIG. 4 is a sectional view of a semiconductor device 100 including the wiring board 50;

FIG. 5 is a sectional view illustrating a resin sealing process to cover a semiconductor element 60 with sealing resin 70 in a manufacturing process of the semiconductor device 100 shown in FIG. 4;

FIG. 6 is a partial enlarged view of a section showing that the wiring board 50 and a die 110 are in contact with each other in the resin sealing process illustrated in FIG. 5;

FIG. 7 is a flow chart illustrating a manufacturing method of the dry film 1 according to the first embodiment of the present invention;

FIG. 8 is a flow chart illustrating a manufacturing method of the wiring board 50;

FIG. 9 is a partial sectional view showing a dry film 1 according to a second embodiment of the present invention;

FIG. 10 is a partial sectional view of a wiring board 50 having a solder resist film 20A and a solder resist film 35A at the surface thereof, which are formed by respectively curing a solder resist film 20 and a solder resist film 35;

FIG. 11 is a sectional view showing that the wiring board 50 shown in FIG. 10 is in contact with the die 110 in the resin sealing process;

FIG. 12 is a sectional view showing a dry film 1 according to a third embodiment of the present invention;

FIG. 13 is a partial sectional view of a wiring board 50 having a solder resist film 20A, a solder resist film 35A and a solder resist film 37A at the surface thereof, which are formed by respectively curing a solder resist film 20, a solder resist film 35, and a solder resist film 37;

FIG. 14 is a flow chart illustrating a manufacturing method of the dry film 1 according to the third embodiment of the present invention; and

FIG. 15 is a partial sectional view showing a dry film 1 according to a fourth embodiment of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Dry films according to embodiments of the present invention will be described below with reference to the accompanying drawings.

### First Embodiment

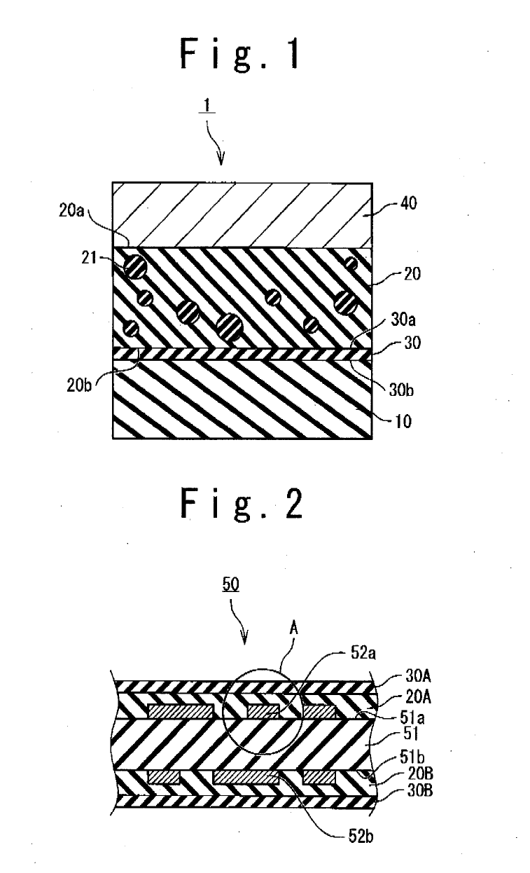

A first embodiment of the present invention is described below. FIG. 1 is a sectional view of a dry film 1 according to the present embodiment. Referring to FIG. 1, the dry film 1 includes a supporting film 10, a solder resist film 20, a second solder resist film 30 and a protection film 40.

The supporting film 10 is a base material on which the solder resist film 20, the solder resist film 30 and the protection film 40 are formed. The supporting film 10 prevents deformations of the solder resist film 20, the solder resist film 30 and the protection film 40. A known material which can support the solder resist film can be used to form the supporting film 10. For example, in addition to polyester such as PET (polyethylene terephthalate) and PEN (polyethylene naphthalate), polypropylene and polyethylene can be used.

The solder resist film 20 and the solder resist film 30 are insulating films formed on the supporting film 10. Specifically, the solder resist film 30 is formed on the supporting film 10, and the solder resist film 20 is formed on the solder resist film 30. The solder resist film 20 has surfaces 20a and 20b opposite to each other. The solder resist film 30 has surfaces 30a and 30b opposite to each other. The surface 20a is adhered to the protection film 40. The surface 20b is bonded to the surface 30a. The surface 30b is adhered to the supporting film 10. Adhesion strength of the surface 30b of the solder resist film 30 is weaker than adhesion strength of the surface 20b of the solder resist film 20. Therefore, when the solder resist film 20 and the solder resist film 30 are bonded to another member by using the dry film 1 such that the solder resist film 30 is arranged outside, a solder resist layer having weak adhesion strength is formed on a surface of the other member. When the solder resist film 20 and the solder resist film 30 are bonded to the other member, the surface 20a is bonded to the other member. Namely, the surface 20a functions as a bonding surface of the dry film 10. Each of the solder resist film 20 and the solder resist film 30 includes resin such as a photosensitive resin known as solder resist. Therefore, the solder resist film 20 and the solder resist film 30 are formed by coating solder resist materials including such resin on the supporting film 10 and by drying the coated materials. The solder resist film 20 and the solder resist film 30 will be cured by a step of irradiating light such as ultraviolet rays, a step of heating, or the like.

The solder resist film 20 includes first elastomer 21, The first elastomer 21 can relieve an internal stress of the solder resist film 20. Any known elastomer which can relieve the internal stress of the solder resist film 20 is user as the first elastomer 21. Details of the solder resist film 20, the solder resist film 30 and the first elastomer 21 will be described later.

The protection film 40 is formed on the solder resist film 20 to protect the solder resist film 20. The protection film 40 can prevent the solder resist film 20 from being bonded to the supporting film 10 when the dry film 1 is rolled up. The protection film 40 is formed by polyolefin such as PE (polyethylene) and PP (polypropylene), polyester, or the like.

By using the dry film 1, it is easy to bond the solder resist film 20 and the solder resist film 30 to surfaces of a wiring board. The bonded solder resist film 20 and the solder resist film 30 are cured based on resist patterns to protect the wiring board. FIG. 2 is a partial sectional view of a wiring board 50 including solder resist films 20A and 30A as the solder resist films 20 and 30 cured based on a resist pattern, and solder resist films 20B and 30B as the solder resist films 20 and 30 cured based on a resist pattern. Referring to FIG. 2, the solder resist film 20A, 20B, 30A and 30B are described in details.

Referring to FIG. 2, the wiring board 50 includes an insulating layer 51 having surfaces 51a and 51b opposite to each other, a wiring layer 52a formed on the surface 51a, a wiring layer 52b formed on the surface 51b, the solder resist film 20A formed on the surface 51a and the wiring layer 52a, the solder resist film 30A formed on the solder resist film 20A, the solder resist film 20B formed on the surface 51b and the wiring layer 52b, and the solder resist film 30B formed on the solder resist film 20B. The insulating layer 51 and the wiring layers 52a and 52b may be referred to as a core of the wiring board 50. The surfaces of the wiring board 50 are protected by the solder resist films 20A, 30A, 20B and 30B.

The insulating layer 51 is a base material on which the wiring layers 52a and 52b are formed and prevents electrical conduction between the wiring layers 52a and 52b. The insulating layer 51 is, for example, a glass epoxy board, a glass composite board or the like. Another wiring layer (not shown) other than the wiring layers 52a and 52b may be formed in the insulating layer 51. Moreover, a through hole may be formed in the insulating layer 51 to connect between a predetermined wiring line in the wiring layer 52a and a predetermined wiring line in the wiring layer 52b.

The wiring layer 52a is a group of conductive wiring lines formed in a predetermined pattern on the surface 51a of the insulating layer 51. The wiring layer 52b is a group of conductive wiring lines formed in a predetermined pattern on the surface 51b of the insulating layer 51. Each of the wiring layers 52a and 52b has a thickness of 10 to 35 μm, for example.

Referring to FIG. 2, the solder resist films 20A and 20B are provided inside the wiring board 50 and the solder resist films 30A and 30B are provided at the surfaces of (i.e., outside) the wiring board 50. That is, after the protection film 40 of the dry film 1 is removed, the surface 20a of the solder resist film 20 is bonded to the surface 51a and the wiring layer 52a, and the surface 20a of the solder resist film 20 is bonded to the surface 51b and the wiring layer 52b. Opening portions are formed in the solder resist film 20A and 30A such that portions of wiring layer 52a are exposed to form electrode pads (not shown). Wires for wire bonding or solder balls for flip-chip bonding are connected to the electrode pads. Opening portions are formed in the solder resist film 20B and 30A such that portions of wiring layer 52b are exposed to form electrode pads (not shown) on which solder balls as external terminals are provided.

Note that the wiring board 50 may be a multilayer wiring board in which one or more wiring layers are provided in the insulating layer 51. Also, the wiring board 50 may not include the wiring layer 52b and the solder resist films 20B and 30B.

Film thicknesses of the solder resist films 20A and 20B are described below. The solder resist films 20A and 20B cover and protect the wiring layers 52a and 52b, respectively. Further, since each of the solder resist films 20A and 20B has insulating properties, short circuits among wiring lines in the wiring layer 52a and short circuits among wiring lines in the wiring layer 52b are prevented. Therefore, a lower limit of the film thickness of the solder resist film 20A is a smallest film thickness required to cover the wiring layer 52a, and an upper limit of the film thickness of the solder resist film 20A is a largest film thickness which can prevent crack due to a strain in manufacturing and usage of a product including the wiring board 50. Lower and upper limits of the film thickness of the solder resist film 203 are similar to those of the solder resist film 20A. The film thickness of each of the solder resist films 20A and 20B is, for example, 25 to 70 μm. The solder resist film 20 shown in FIG. 1 is formed to secure the above film thicknesses of the solder resist films 20A and 203 in consideration of change in film thickness due to volatilization of solvent included in the solder resist film 20 and contraction in the curing.

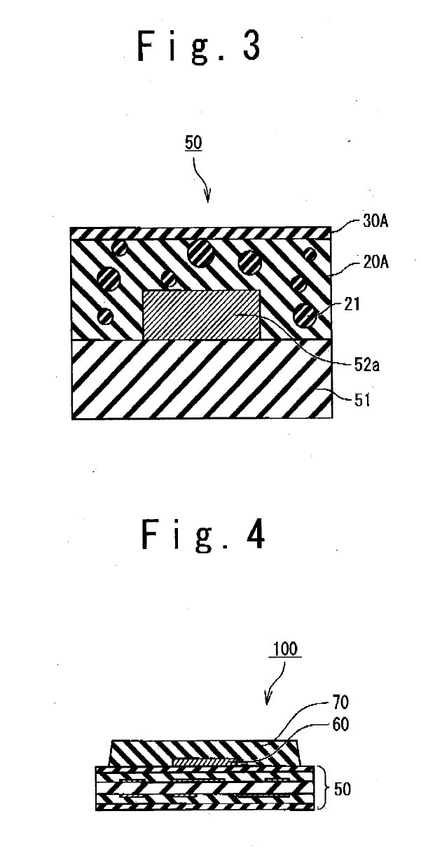

Next, the first elastomer 21 included in the solder resist film 20A and 20B to relieve internal stress are described in detail below. FIG. 3 is an enlarged view of a portion in a circle A shown in FIG. 2. Referring to FIG. 3, the first elastomer 21 is polymer dispersed in solder resist film 20A as particles having mean diameter of 5 to 15 μm. The first elastomer 21 has a glass transition point equal to or lower than 150 degree Celsius and is softened to present adhesiveness at a temperature equal to or higher than the glass transition point. The necessity to relieve the internal stress by the first elastomer 21 is described below.

FIG. 4 is a sectional view of a semiconductor device 100 including the wiring board 50. Referring to FIG. 4, the semiconductor device 100 includes the wiring board 50, a semiconductor element 60 and a sealing resin 70.

The semiconductor element 60 is provided with wiring patterns for implementing various kinds of functions and is connected to the wiring board 50. The semiconductor element 60 is connected to the wiring board 50 by either of wire bonding or flip-chip bonding. The sealing resin 70 covers and protects the semiconductor element 60.

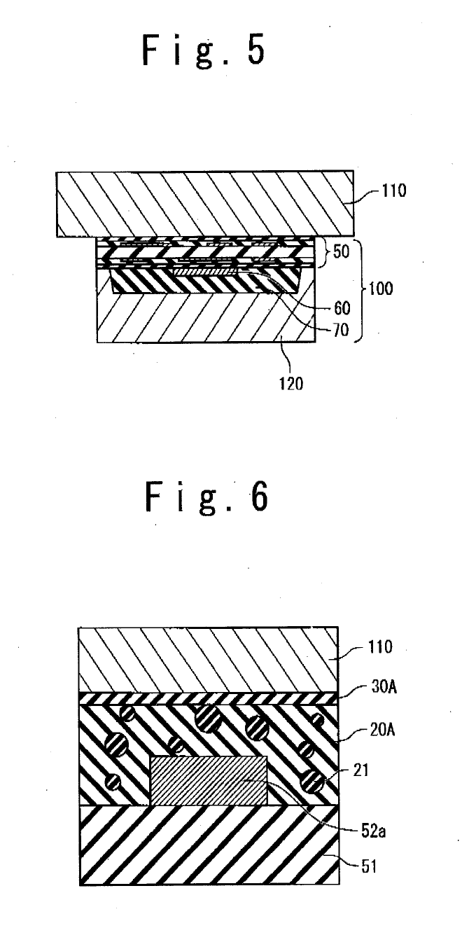

FIG. 5 is a sectional view showing a resin sealing process included in a manufacturing process of the semiconductor device 100 shown in FIG. 4. In the resin sealing process, the semiconductor element 60 is covered with the sealing resin 70. The resin sealing process is described referring to FIG. 5. Dies 110 and 120 covers and encloses the wiring board 50 mounting the semiconductor element 60 to form a cavity in which the sealing resin 70 is filled. The sealing resin 70 in a state of a high temperature fluid is filled in the cavity formed by the dies 110 and 120. It is noted here that when filled in the cavity, the sealing resin 70 is not necessarily to be in liquid state but may be in a state of having fluidity (rubbery state). The following describes the case of liquid state. The die 110, the die 120, the wiring board 50 and the semiconductor element 60 are heated to approximately 150 to 200 degree Celsius to fully cure the sealing resin 70 in a fluid state. The sealing resin 70 in the fluid state is cured by heating. Since the solder resist film 20A has a portion positioned between the wiring board 50 and the semiconductor element 60, the solder resist film 20A is required to withstand a strain due to thermal deformations of the wiring board 50 and the semiconductor element 60 in the resin sealing process. The first elastomer 21 relieves an internal stress due to the strain and prevents the solder resist film 20A from being cracked and being detached from the insulating layer 51.

However, since the first elastomer 21 is softened at a temperature equal to or higher than the glass transition point, the first elastomer 21 is easily adhered to other member. Therefore, when the first elastomer 21 were exposed at the surfaces of the wiring board 50, there arises a problem that it is difficult to remove the wiring board 50 from the dies 110 and 120 in the resin sealing process. In the wiring board 50 manufactured by using the dry film 1 according to the present embodiment, the solder resist film 30A and 30B prevent the first elastomer 21 exposed on the surfaces of the solder resist films 20A and 20B from being in contact with the dies 110 and 120.

Film thicknesses of the solder resist films 30A and 30B are described. Referring to FIG. 2, the cured solder resist films 30A and 30B for protecting the wiring board 50 are insulating films which cover the solder resist films 20A and 20B and are arranged at the surfaces of the wiring board 50. A solder resist pattern is formed in the solder resist films 20A and 30A such that the wiring layer 52a is partially exposed. A solder resist pattern is formed in the solder resist films 20B and 30B such that the wiring layer 52b is partially exposed. Electrode pads are formed at the exposed portions of the wiring layers 52a and 52b. The cured solder resist films 30A and 30B at the surfaces of the wiring board 50 prevents any portion other than the electrode pads from being electrically connected.

The solder resist film 30 of the dry film 1 does not include the first elastomer 21. Since the solder resist film 30 does not include the first elastomer 21, adhesion strength of the surface 30b of the solder resist film 30 is weaker than that of the surface 20b of the solder resist film 20 at the glass transition point of the first elastomer 21. This similarly applies to the cured solder resist films 30A and 30B at the surface of the wiring board 50, Therefore, in the resin sealing process shown in FIG. 5, each of the cured solder resist films 30A and 305 at the surfaces of the wiring board 50 has weak adhesion strength to the die 110 or 120. Moreover, the resin included in the solder resist films 30A and 30B is hard to be adhered to the dies 110 and 120 due to a heat in the resin sealing process. Therefore, even when heated to a temperature equal to or more than the glass transition point of the first elastomer 21 in the resin sealing process, the solder resist films 30A and 30B are hard to be adhered to the dies 110 and 120. It is preferable that the composition of the solder resist films 30A and 30B is the same as that of the solder resist films 20A and 20B except for the first elastomer 21. In particular, it is preferable that resin components of each of the solder resist films 30A and 30B are same as resin components of each of the solder resist films 20A and 208, since the solder resist film 30A (or 30B) is strongly bonded to the solder resist film 20A (20B) in this case. It is noted here that the resin components of the solder resist film indicate a base material of the solder resist film and do not include elastomer.

Film thicknesses of the solder resist films 30A and 30B are described below referring to FIG. 3. A lower limit of the film thickness of the solder resist film 30A is a smallest film thickness required to cover the first elastomer 21 exposed on the surface of the solder resist film 20A, and an upper limit of the film thickness of the solder resist film 30A is a largest film thickness which can prevent crack due to a strain in manufacturing and usage of a product including the wiring board 50. Lower and upper limits of the film thickness of the solder resist film 30B are similar to those of the solder resist film 30A. That is, the cured solder resist films 30A and 30B at the surfaces of the wiring board 50 prevents the first elastomer 21 exposed on the surfaces of the solder resist films 20A and 20B from being exposed on the surfaces of the wiring board 50 so as to prevent the first elastomer 21 from being adhered to the dies 110 and 120 in the resin sealing process, respectively. The film thickness of each of the solder resist films 30A and 30B is, for example, 1 to 10 μm, more preferably, 1 to 2 μm. That is, the solder resist film 30 shown in FIG. 1 is formed to secure the above film thicknesses of the solder resist films 30A and 30B in consideration of change in film thickness due to volatilization of solvent included in the solder resist film 30 and contraction in the curing.

FIG. 6 is a partial enlarged view of a section showing that the wiring board 50 and the die 110 are in contact with each other in the resin sealing process illustrated in FIG. 5. Referring to FIG. 6, since the cured solder resist film 30A does not include the first elastomer 21, which is softened by heating to be adhered to the die 110, the solder resist film 30A can be easily detached from die 110. Although not shown in FIG. 6, the solder resist film 30B can be easily detached from the die 120, similarly. Therefore, when the solder resist films 20A and 20B and the solder resist films 30A and 30B are formed at the surfaces of the wiring board 50 using the dry film 1 according to the first embodiment of the present invention, since the solder resist films 30A and 30B can be easily detached from the dies 110 and 120, a manufacturing throughput of the semiconductor device 100 can be improved. Note that each of the solder resist films 30A and 30B may include no elastomer at all, or may include elastomer which is harder to be softened by heating than the first elastomer 21.

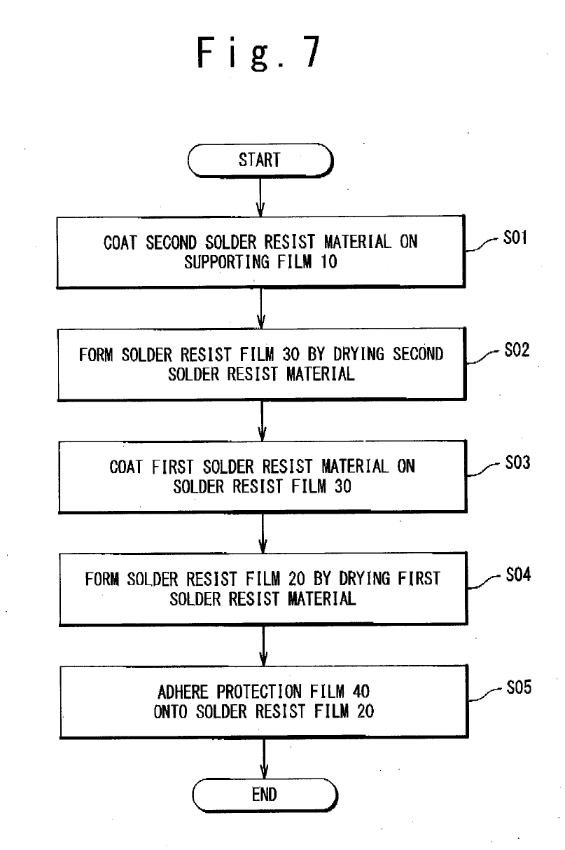

FIG. 7 is a flow chart showing a manufacturing method of the dry film 1 according to the first embodiment of the present invention. Referring to FIG. 7, the manufacturing method of the dry film 1 according to the first embodiment of the present invention is described.

Second solder resist material is coated on the supporting film 10 (Step S01). A spray method, a screen printing method, a roller coating method or a curtain coating method is used as a coating method of the second solder resist material, for example.

The solder resist film 30 is formed by drying the coated second solder resist material through a heat treatment (Step S02). The heat treatment is performed for 1 to 30 minutes in a temperature range of 60 to 100 degree Celsius, for example. The solder resist film 30 is formed to have a film thickness of 1 to 10 μm, preferably 1 to 2 μm after being cured.

First solder resist material including the first elastomer 21 is coated on the solder resist film 30 (Step S03). A coating method of the first solder resist material is similar to that of the second solder resist material.

The solder resist film 20 is formed by drying the coated first solder resist material through a heat treatment (Step S04). The heat treatment is performed for 1 to 30 minutes in a temperature range of 60 to 100 degree Celsius. The solder resist film 20 is formed to have a film thickness of 25 to 70 μm after the solder resist 20 is cured. The film thickness of the solder resist film 30 is smaller than the film thickness of the solder resist film 30.

The protection film 40 is adhered onto the solder resist film 20 (Step S05).

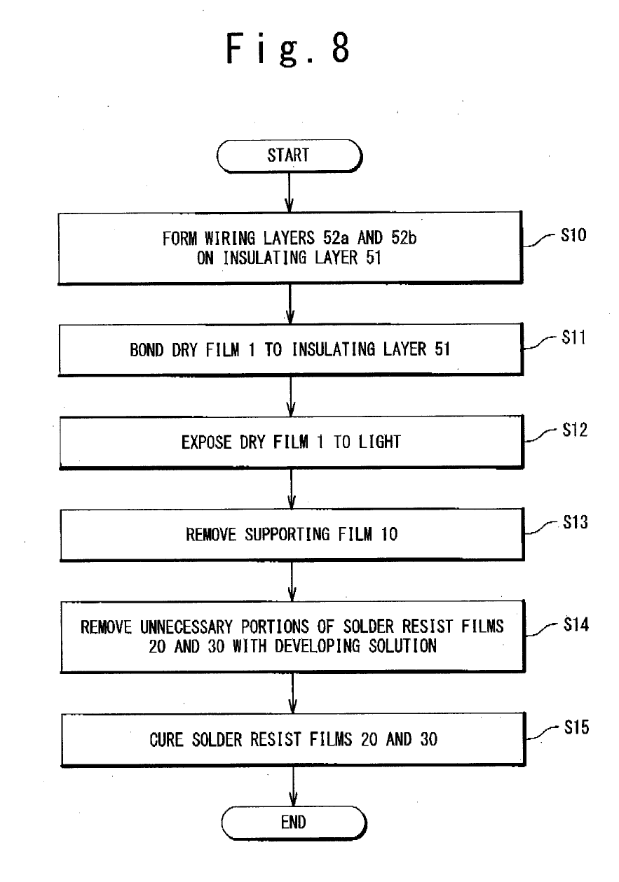

FIG. 8 is a flow chart illustrating a manufacturing method of the wiring board 50. Referring to FIG. 8, the manufacturing method of the wiring board 50 using the dry film 1 according to the present embodiment is described.

The wiring layers 52a and 52b are formed on the surfaces 51a and 51b of the insulating layer 51 having insulating properties, respectively (Step S10). The insulating layer 51 is a glass epoxy board, a glass composite board or the like, A known wiring pattern forming method such as etching can be used for forming the wiring layers 52a and 52b.

The protection film 40 is removed from the dry film 1 such that the solder resist film 20 is exposed at the surface of the dry film 1. The dry film 1 including the solder resist film 20, the solder resist film 30 and the supporting film 10 is bonded to the surface 51a of the insulating layer 51 and the wiring layer 52a to cover the surface 31a and the wiring layer 52a, and is bonded to the surface 51b of the insulating layer 51 and the wiring layer 52b to cover the surface 51b and the wiring layer 52b (Step S11). Here, the dry film 1 is bonded to the core of the wiring board 50 such that the solder resist film 20 is in contact with the core of the wiring board 50. A known method such as a thermo-compression bonding may be used for the bonding of the dry film 1. For example, a pressure is applied on the supporting film 10 of the dry film 1 toward the insulating layer 51 to effectively perform the bonding.

The dry film 1 is exposed to irradiation of light such as ultraviolet rays through a mask based on a resist pattern (Step S12). A laser beam may be used in place of the light through the mask. The solder resist film 20 and the solder resist film 30 may be either a negative type in which solubility to a developing solution is lowered upon exposure and the exposed portions remain after development or a positive type in which a solubility to a developing solution is increased upon exposure and exposed portions are removed.

The supporting film 10 is removed from the solder resist film 30 (Step S13).

Unnecessary portions of the exposed solder resist films 20 and 30 are removed with a developing solution (Step S14).

The solder resist films 20 and 30 are cured by any one or both of heating and irradiation of ultraviolet rays (Step S15). The solder resist films 20 and 30 are heated for 30 to 60 minutes in a temperature range of 100 to 200 degree Celsius, for example. The cured solder resist film 20 is referred to as the solder resist film 20A or 20B, and the cured solder resist film 30 is referred to as the solder resist film 30A or 30B.

The dry film 1 according to the first embodiment of the present invention includes the solder resist film 20 which includes the first elastomer 21 that is softened by heating and the solder resist film 30 which does not include the first elastomer. By using the dry film 1, the solder resist film 30A or 30B which does not include the first elastomer 21 can be easily formed at the surfaces of the wiring board 50. Therefore, since the surfaces of the wiring board 50 manufactured using the dry film 1 according to the present embodiment do not present adhesiveness even when heated, the wiring board 50 is hard to be adhered to the dies 110 and 120. In other words, the dry film 1 can facilitate the semiconductor device 100 to be easily taken out from the dies 110 and 120 after heating in the resin sealing process of the semiconductor device 100 in which the wiring board 50 is used. Therefore, it takes less time for a step of detaching the wiring board 50 from the dies 110 and 120 and for a step of cleaning the dies 110 and 120, whereby the manufacturing throughput of the semiconductor device 100 can be improved. Moreover, by using the dry film 1, contaminants are hard to adhere to the dies 110 and 120. Accordingly, the contaminants are prevented from being transferred to the wiring board 50, thereby preventing an assembly deficiency that the wiring board 50 and a solder ball are not bonded each other. In particular, the dry film 1 can prevent a poor connection between the electrode pad at the opening portion and a bonding wire or between the electrode pad and a solder ball when the bonding wire or the solder ball is electrically connected with the electrode pad. Further, since the wiring board 50 manufactured by using the dry film 1 is easily detached from the dies 110 and 120, electrostatic discharge is prevented when the semiconductor device 100 is detached from the dies 110 and 120, thereby preventing a malfunction of the semiconductor device 100 for semiconductor element 60).

### Second Embodiment

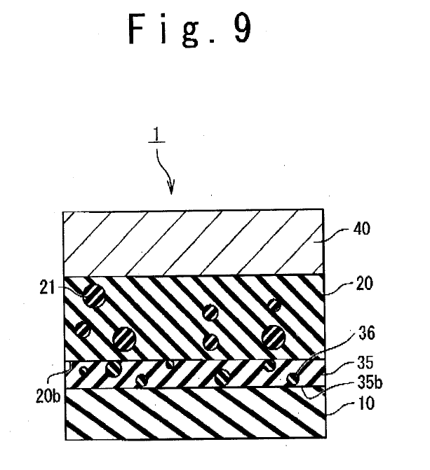

A second embodiment of the present invention is described. A dry film 1 according to the second embodiment of the present invention is different from the dry film 1 according to the first embodiment in the configuration of the solder resist film 30. Since the other configurations are the same as those of the first embodiment, the same components are denoted by the same reference symbols and the explanations thereof are omitted. FIG. 9 is a partial sectional view showing the dry film 1 according to the second embodiment of the present invention.

Referring to FIG. 9, the dry film 1 includes the supporting film 10, the solder resist film 20, a solder resist film 35 and the protection film 40. The supporting film 10, the solder resist film 20 and the protection film 40 are the same as those of the first embodiment.

The solder resist film 35 includes second elastomer 36. Similarly to the first elastomer 21, the second elastomer 36 is polymer dispersed as particles in the solder resist film 35 to relieve an internal stress. The second elastomer 36 has a glass transition point equal to or lower than a temperature for curing the sealing resin 70 (e.g., 150° C. or lower) and is softened to present adhesiveness at a temperature equal to or higher than the glass transition point. Known compositions are used as compositions of a base material of the solder resist film 35 and the second elastomer 36, and it is preferred that the compositions of the base material of the solder resist film 35 and the second elastomer 36 are same as those of the base material of the solder resist film 20 and the first elastomer 21.

Similarly to the solder resist film 30, the solder resist film 35 is cured at the surface of the wiring board 50 to protect the wiring board 50. Although the cured solder resist film 35 includes the second elastomer 36 which is softened by heating to present adhesiveness, the cured solder resist film 35 is harder to be adhered to each of the dies 110 and 120 than the solder resist films 20A and 20B in the resin sealing process shown in FIG. 5. That is, adhesion strength of a surface 35b of the solder resist film 35 is weaker than adhesion strength of the surface 20b of the solder resist film 20 at the glass transition point of the first elastomer 21 (i.e., a temperature at which the surface 20b present adhesiveness). More specifically, an area of surfaces of particles of the second elastomer 36, which are exposed on the surface 35b of the solder resist film 35, is smaller than an area of surfaces of particles of the first elastomer 21, which are exposed on the surface 20b of the solder resist film 20; or the glass transition point of the second elastomer 36 is higher than the glass transition point of the first elastomer 21. This similarly applies to both of the solder resist film 35 of the dry film 1 and the solder resist film 35 having been cured at the surface of the wiring board 50.

The following describes a mixed amount of the second elastomer 36 in the solder resist film 35 and a mean diameter of the particles of the second elastomer 36 required to achieve that the area of surfaces of particles of the second elastomer 36, which are exposed on the surface 35a of the solder resist film 35, is smaller than the area of surfaces of particles of the first elastomer 21, which are exposed on the surface 20b of the solder resist film 20. A mass ratio of the second elastomer 36 to resin components of the solder resist film 35 is smaller than a mass ratio of the first elastomer 21 to resin components of the solder resist film 20. Since the mixed amount of the second elastomer 36 in the solder resist film 35 is small, the area of surfaces of particles of the second elastomer 36, which are exposed on the surface 35b of the solder resist film 35, is small. Furthermore, the mean diameter of the particles of the second elastomer 36 is smaller than that of the first elastomer 21. The mean diameter of the particles of the second elastomer 36 is, for example, 5 μm or smaller. Thus, a combination of the small mixed amount of the second elastomer 36 in the solder resist film 35 and the small mean diameter of the second elastomer 36 further reduces the area of surfaces of particles of the second elastomer 36, which are exposed on the surface 35a of the solder resist film 35.

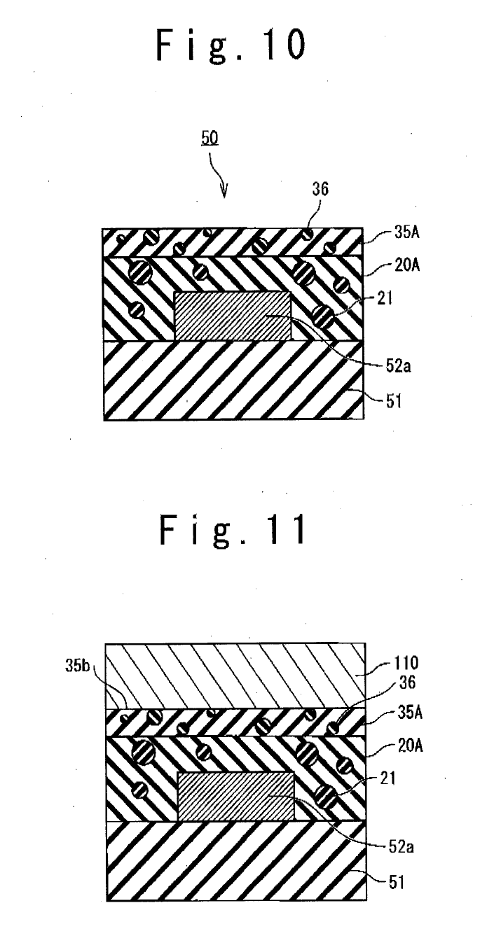

A film thickness of the solder resist film 35 is described below. FIG. 10 is a partial sectional view of the wiring board 50. The wiring board 50 includes the insulating layer 51, the wiring layer 52a formed on the insulating layer 51, the solder resist film 20A arranged on the wiring layer 52a, and a solder resist film 35A arranged on the solder resist film 20A. The solder resist films 20 and 35 are bonded to the insulating layer 51 and the wiring layer 52a and then cured to be the solder resist films 20A and 35A. The solder resist film 35A is positioned at the surface of the wiring board 50. A lower limit of the film thickness of the solder resist film 35A is a film thickness larger than the mean diameter of the particles of the second elastomer 36, and an upper limit of the film thickness of the solder resist film 35A is a film thickness smaller than the film thickness of the solder resist film 20A. The lower limit is, for example, 5 μm or larger. This is because, if the lower limit of the film thickness of the solder resist film 35A is smaller than the mean diameter of the particles of the second elastomer 36, a large number of particles of the second elastomer 36 are exposed on the surface of the wiring board 50 and thus, the wiring board 50 is easily adhered to the dies 110 and 120. Although each of the solder resist films 20A and 35A can relieve the internal stress, since it is preferable that the internal stress is mainly relieved by the solder resist film 20A including the first elastomer 21, it is preferable that the upper limit of the film thickness of the solder resist film 35A does not exceed the film thickness of the solder resist film 20A. That is, since the film thickness of the solder resist film 35 of the dry film 1 shown in FIG. 9 changes due to volatilization of solvent included in the solder resist film 35 and contraction in the curing, the solder resist film 35 is formed to secure the above film thickness of the solder resist film 35A.

FIG. 11 is a sectional view showing that the wiring board 50 shown in FIG. 10 is in contact with the die 110 in the resin sealing process. Referring to FIG. 11, the surface 35b of the solder resist film 35A is in contact with the die 110. Since the area of surfaces of particles of the second elastomer 36, which are exposed on the surface 35b, is small, the solder resist film 35A can be easily detached from the die 110. Although not shown in FIG. 11, the solder resist film 35 having been cured on the opposite side of the wiring board 50 can be easily detached from the die 120, similarly.

A manufacturing method of the dry film 1 according to the second embodiment of the present invention is similar to the manufacturing method of the dry film 1 according to the first embodiment illustrated in FIG. 7. Referring to FIG. 7, the steps different from those of the first embodiment are described. In Step S01, second solder resist material including the second elastomer 36 instead of the second solder resist material is coated on the supporting film 10. A coating method of the second solder resist material including the second elastomer 36 is similar to that of the first solder resist material. In Step S02, the solder resist film 35 is formed by drying the coated second solder resist material including the second elastomer 36 through a heat treatment. The heat treatment is similar to that in the case of the first solder resist material. The solder resist film 35 is formed such that the solder resist film 35 has a film thickness equal to or larger than 5 μm and smaller than the solder resist film 20A after being cured. The film thickness of the solder resist film 35 is smaller than the film thickness of the solder resist film 20. The other steps are similar to those of the first embodiment.

Since the manufacturing method of the wiring board 50 using the dry film 1 according to the second embodiment of the present invention is similar to that of the first embodiment illustrated in FIG. 8, the explanation thereof is omitted.

The dry film 1 according to the second embodiment of the present invention includes the solder resist film 35. The area of surfaces of particles of the second elastomer 36, which are exposed on the surface 35b of the solder resist film, is small. By adhering the dry film 1 to the insulating layer 51 such that the solder resist film 20 is contact with the insulating layer 51, the solder resist film 35 can be easily arranged at the surface of the wiring board 50. Since the cured solder resist film 35A is arranged at the surface of the wiring board 50, the surface of the wiring board 50 presents a very weak adhesiveness when heated and the wiring board 50 is hard to be adhered to the dies 110 and 120. Thus, similarly to the first embodiment, the dry film 1 according to the second embodiment can improve the manufacturing throughput of the semiconductor device 100, since the semiconductor device 100 including the wiring board 50 manufactured by using the dry film 1 can be easily taken out from the dies 110 and 120 in the resin sealing process. Moreover, since the second elastomer 36 included in the solder resist film 351 can relieve the internal stress, the dry film 1 according to the second embodiment can improve the prevention of crack in the surface of the wiring board 50.

### Third Embodiment

A third embodiment of the present invention is described. The third embodiment is a combination of the first embodiment and the second embodiment. Therefore, components same as those of the first and second embodiments are denoted by the same reference symbols and the explanations thereof are omitted.

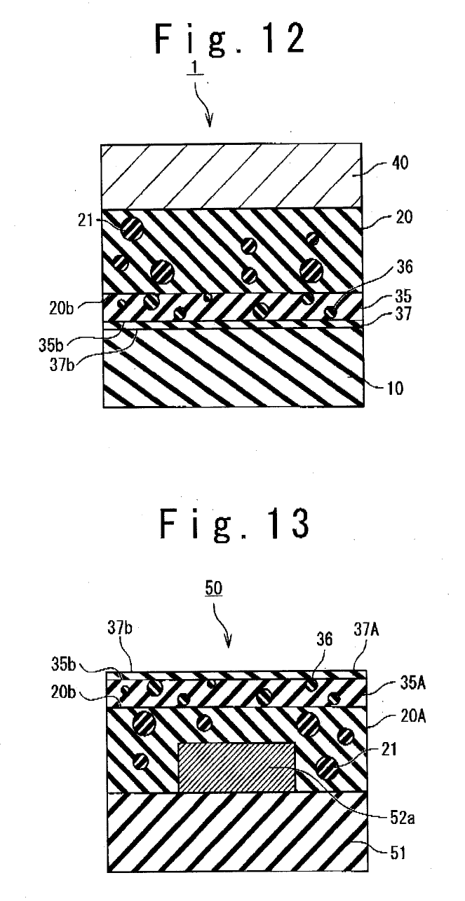

FIG. 12 is a sectional view of the dry film 1 according to the third embodiment of the present invention. Referring to FIG. 12, the dry film 1 according to the third embodiment of the present invention includes the supporting film 10, the solder resist film 20, the solder resist film 35, a solder resist film 37 and the protection film 40. The supporting film 10, the solder resist film 20, the solder resist film 35 and the protection film 40 are the same as those of the first or second embodiments.

Referring to FIG. 12, the solder resist film 37 is described. The solder resist film 37 is formed between the supporting film 10 and the solder resist film 35. Therefore, when the dry film 1 is bonded to the core of the wiring board 50 such that the solder resist film 20 is in contact with the core of the wiring board 50, the solder resist film 37 serves as an insulating film positioned at the surface of the wiring board 50. The solder resist film 37 does not include elastomer similar to any of the first elastomer 21 and the second elastomer 36. Since the solder resist film 37 does not include adhesive components, adhesion strength of a surface 37b of the solder resist film 37 is weaker than adhesion strength of the surfaces 35b and 20b of the solder resist films 35 and 20 at the glass transition point of the first elastomer 21 or the second elastomer 36. This applies to both of a state that the solder resist films 20, 35 and 37 are portions of the dry film 1 and a state that the solder resist films 20, 35 and 37 have been cured at the surface of the wiring board 50. The solder resist film 37 does not include elastomer. The composition of the solder resist film 37 is preferably same as those of the first and second solder resist films 20 and 35, except for the elastomer.

A film thickness of the solder resist film 37 is described. FIG. 13 is a partial sectional view of the wiring board 50. The wiring board 50 includes solder resist films 20A, 35A and 37A. The solder resist films 20A, 35A and 37A are the solder resist films 20, 35 and 37 have been cured on the core of the wiring board 50. Referring to FIG. 13, the solder resist film 37A is an insulating film which is formed to cover the solder resist film 35A and positioned at the surface of the wiring board 50. A pattern is formed in the solder resist film 37A similarly to the solder resist films 20A and 35A such that the wiring layer 52a is partly exposed to form electrode pads (not shown). The solder resist film 37A prevents short circuit in which any portion of the wiring layer 52a other than the electrode pads is electrically connected. Since the mean diameter of the particles of the second elastomer 36 included in the solder resist film 35A is smaller than the mean diameter of the particles of the first elastomer 21 included in the solder resist film 20A, the film thickness of the solder resist film 37A can be designed to be smaller than the film thickness of the solder resist film 30A according to the first embodiment. Specifically, the film thickness of the solder resist film 37A can be 1 μm or smaller. That is, since the film thickness of the solder resist film 37 of the dry film 1 shown in FIG. 12 changes due to volatilization of solvent included in the solder resist film 37 and contraction in the curing, the solder resist film 37 is formed to secure the above film thickness of the solder resist film 37A.

Since the adhesion strength of the surface 37b of the solder resist film 37A is weaker than the adhesion strength of the surfaces 35b and 20b of the solder resist films 35A and 20A at the glass transition point of the first elastomer 21 or the second elastomer 36, the solder resist film 37A at the surface of the wiring board 50 is hard to be adhered to die 110 even when heated in the resin sealing process.

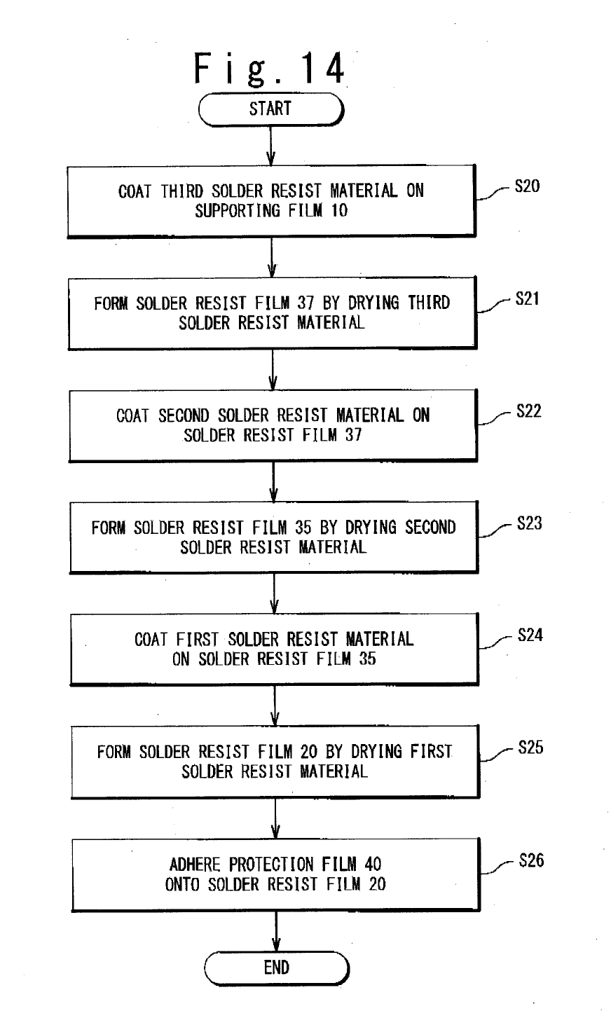

FIG. 14 is a flow chart showing a manufacturing method of the dry film 1 according to the third embodiment of, the present invention. Referring to FIG. 14, the manufacturing method of the dry film 1 according to the third embodiment of the present invention is described.

Third solder resist material is coated on the supporting film 10 (Step S20). Similarly to the first and second embodiments, a spray method, a screen printing method, a roller coating method or a curtain coating method is used as a coating method of the third solder resist material, for example.

The solder resist film 37 is formed by drying the coated third resist material through a heat treatment (Step S21). The heat treatment is performed for 1 to 30 minutes in a temperature range of 60 to 100 degree Celsius, for example The solder resist film 37 is formed to have a film thickness of 1 μm or smaller after being cured.

The second solder resist material including the second elastomer 36 is coated on the solder resist film 37 (Step S22). A coating method of the second solder resist material is similar to that of the third solder resist material.

The solder resist film 35 is formed by drying the coated second solder resist material including the second elastomer 36 through a heat treatment (Step S23). The heat treatment is similar to that for the third solder resist material. The solder resist film 35 is formed to have a film thickness of 5 μm or larger after being cured. The film thickness of the solder resist film 37 may be smaller than the film thickness of the solder resist film 35. The solder resist film 35 is formed to have a film thickness smaller than that of the solder resist film 20 to be formed in the following step.

The first solder resist material including the first elastomer 21 is coated on the solder resist film 35 (Step S24). A coating method of the first solder resist material is similar to those of the second solder resist material and the third solder resist material.

The solder resist film 20 is formed by drying the coated first solder resist material through a heat treatment (Step S25). The heat treatment is performed for 1 to 30 minutes in a temperature range of 60 to 100 degree Celsius, for example. The solder resist film 20 is formed to have a film thickness of 25 to 70 μm after being cured.

The protection film 40 is adhered onto the solder resist film 20 (Step S26).

Since the manufacturing method of the wiring board 50 using the dry film 1 according to the third embodiment of the present invention is similar to that of the first embodiment illustrated in FIG. 8, the explanation thereof is omitted.

The dry film 1 according to the third embodiment of the present invention is a layered product provided by combining the first and second embodiments of the present invention. As mentioned above, the embodiments can be combined within a range of not causing contradictions. The dry film 1 according to the third embodiment includes the solder resist film 37 which does not include any of the first and second elastomers 21 and 36 that are softened by heating. By using the dry film 1 according to the third embodiment, the solder resist film 37A can be easily formed at the surface of the wiring board 50. Therefore, the wiring board 50 manufactured by using the dry film 1 according to the third embodiment does not present adhesiveness on the surface thereof even when being heated and is hard to adhered to the die. Since the mean diameter of particles of the second elastomer 36 included in the solder resist film 35 is smaller than the mean diameter of particles of the first elastomer 21, the thickness of the solder resist film 37 can be smaller than the thickness of the solder resist film 30 according to the first embodiment. Since the wiring board 50 can be easily taken out from the dies 110 and 120 in the resin sealing process included in the manufacturing process of the semiconductor device 100, the dry film 1 according to the third embodiment of the present invention can improve a manufacturing throughput of the semiconductor device 100, similarly to the first and second embodiments.

### Fourth Embodiment

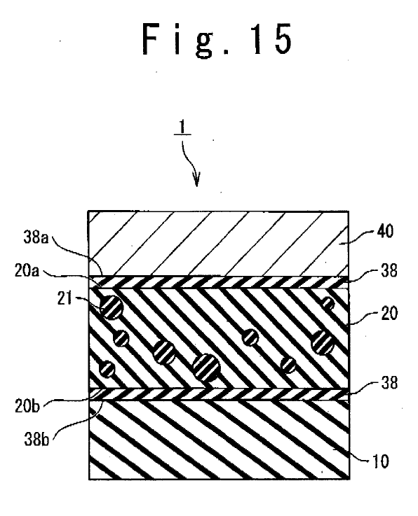

A fourth embodiment of the present invention is described. A dry film 1 according to the fourth embodiment of the present invention is different from the dry film 1 according the first embodiment in a point that solder resist films 38 are provided in place of the solder resist film 30. Since the dry film 1 according to the fourth embodiment is same as the dry film 1 according to the first embodiment in the other configurations, the same components are denoted by the same reference symbols and the explanations thereof are omitted. FIG. 15 is a partial sectional view showing the dry film 1 according to the fourth embodiment of the present invention.

Referring to FIG. 15, the dry film 1 according to the fourth embodiment of the present invention includes the supporting film 10, the solder resist film 20, the solder resist films 38 and the protection film 40. A film thickness of each of the solder resist films 38 is smaller than the film thickness of the solder resist film 20. The supporting film 10, the solder resist film 20 and the protection film 40 are the same as those of the first embodiment.

Referring to FIG. 15, the solder resist films 38 are described below. One of the solder resist films 38 is arranged between the supporting film 10 and the solder resist film 20. The solder resist film 38 has a surface 38b being in contact with the supporting film 10. The other of the solder resist films 38 is arranged between the solder resist film 20 and the protection film 40. The other solder resist film 38 has a surface 38a being in contact with the protection film 40. Similarly to the solder resist film 30 of the first embodiment, each of the solder, resist films 38 does not include elastomer similar to the first elastomer 21 which relieves an internal stress. Since each of the solder resist films 38 does not include the first elastomer 21, adhesion strengths of the surfaces 38a and 38b are weaker than adhesion strengths of the surfaces 20a and 20b. This applies to both of a state that the solder resist films 38 are portions of the dry film 1 and a state that the solder resist films 38 have been cured at the surface of the wiring board 50. Therefore, according to the dry film 1 of the fourth embodiment, the wiring board 50 is hard to be adhered to the dies 110 and 120, a manufacturing throughput of the semiconductor device 100 including the wiring board 50 is improved, and a malfunction of the semiconductor element 60 provided in the semiconductor device 100 is prevented.

Moreover, the solder resist films 38 are formed such that the solder resist film 20 is arranged between the solder resist films 38. Therefore, when the protection film 40 of the dry film 1 is configured to prevent the films 20 and 38 from being deformed similarly to the supporting film 10, the dry film 1 can be bonded to the core of the wiring board 50 at either of the surfaces 38a and 38b of the solder resist films 38.

The first to fourth embodiments can be arbitrarily combined to provide the dry film 1, and a layer structure of the solder resist films of the dry film 1 is not limited to double or triple layer structure. Moreover, positions of the supporting film 10 and the protection film 40 may be inverted in the first to third embodiments. In this case, the protection film 40 and the supporting film 10 are interchanged in FIGS. 1, 9 and 12. In the manufacturing methods of these dry films, after the solder resist film 20 is formed on the supporting film 10, the solder resist film 30 or 35 is formed on the solder resist film 20. In the case of the third embodiment, the solder resist film 37 is formed on the solder resist film 35. Thereafter, the protection film 40 is adhered to the solder resist film 30, 35, or 37. Also, the manufacturing method of the wiring board using any one of the dry films includes steps of: bonding the dry film 1 onto the insulating layer 51; exposing the dry film 1 to light; developing the solder resist films with a developing solution; and curing the solder resist films. In the step of bonding the dry film 1 onto the insulating layer 51, the dry film 1 is bonded on the insulating layer 51 while removing the supporting film 10 from the dry film 1. When each of these dry films is used, since the supporting film 10 of the dry film 1 should be removed when the dry film 1 is bonded onto the insulating layer 51, the bonding is somewhat difficult compared to the cases of dry films shown in FIGS. 1, 9 and 12.

The above-mentioned embodiments can be implemented in combination.

The embodiments of the present invention have been specifically described. However, the present invention is not limited to the above embodiments, but may be modified and changed without departing from the scope and spirit of the invention.

What is claimed is:

1. A dry film comprising:
a first solder resist film including first particles of first elastomer;
a second solder resist film; and
a supporting film supporting said first solder resist film and said second solder resist film,
wherein adhesion strength of a surface of said second solder resist film is weaker than adhesion strength of a surface of said first solder resist film at a glass transition point of said first elastomer.

2. The dry film according to claim 1, wherein said second solder resist film is arranged between said first solder resist film and said supporting film.

3. The dry film according to claim 1, wherein said second solder resist film includes second particles of second elastomer, and
an area of surfaces of said second particles, which are exposed on said surface of said second solder resist film, is smaller than an area of surfaces of said first particles, which are exposed on said surface of said first solder resist film.

4. The dry film according to claim 3, wherein a mass ratio of said second elastomer to resin components of said second solder resist film is smaller than a mass ratio of said first elastomer to resin components of said first solder resist film.

5. The dry film according to claim 4, wherein a mean diameter of said second particles is smaller than a mean diameter of said first particles.

6. The dry film according to claim 1, wherein resin components of said first solder resist film is same as resin components of said second solder resist film.

7. The dry film according to claim 1, wherein a thickness of said second solder resist film is smaller than a thickness of said first solder resist film.

8. The dry film according to claim 1, further comprising a third solder resist film arranged between said first solder resist film and said second solder resist film,
wherein said third solder resist film includes second particles of second elastomer, and
said second solder resist film does not include elastomer.

9. A manufacturing method of a dry film comprising:
forming one of a first solder resist film and a second solder resist film on a supporting film; and
forming another of said first solder resist film and said second solder resist film on or above said one of said first solder resist film and said solder resist film,
wherein said first solder resist film includes first particles of first elastomer, and
adhesion strength of a surface of said second solder resist film is weaker than adhesion strength of a surface of said first solder resist film at a glass transition point of said first elastomer.

10. The manufacturing method of a dry film according to claim 9, wherein said second solder resist film includes second particles of second elastomer, and
an area of surfaces of said second particles, which are exposed on said surface of said second solder resist film, is smaller than an area of surfaces of said first particles, which are exposed on said surface of said first solder resist film.

11. The manufacturing method of a dry film according to claim 9, further comprising forming a third solder resist film on said one of said first solder resist film and said second solder resist film,
wherein said another of said first solder resist film and said second solder resist film is formed on said third solder resist film,
said third solder resist film includes second particles of second elastomer, and
said second solder resist film does not include elastomer.

12. The manufacturing method of a dry film according to claim 10, wherein a mass ratio of said second elastomer to resin components of said second solder resist film is smaller than amass ration of said first elastomer to resin components of said first solder resist film.

13. The manufacturing method of a dry film according to claim 12, wherein a mean diameter of said second particles is smaller than a mean diameter of said first particles.

14. The manufacturing method of a dry film according to claim 9, wherein resin components of said first solder resist film is same as resin components of said second solder resist film.

15. The manufacturing method of a dry film according to claim 9, wherein a thickness of said second solder resist film is smaller than a thickness of said first solder resist film.
